(19) United States
(12) Patent Application Publication
(10) Pub. No.: US 2020/0378105 A1
(43) Pub. Date: Dec. 3, 2020

(54) AUTOMATIC SEWAGE REGULATION SYSTEM AND REGULATING METHOD THEREOF

(71) Applicant: FENRI CO., LTD., New Taipei City (TW)

(72) Inventors: Shueh-Ting LIN, New Taipei City (TW); Shang-Jung WU, New Taipei City (TW); Ya-Chen CHENG, New Taipei City (TW); Yung-Yun CHENG, New Taipei City (TW)

(21) Appl. No.: 16/423,835

(22) Filed: May 28, 2019

(51) Int. Cl. E03F 5/10; C02F 1/00

(52) U.S. Cl. CPC E03F 5/105; C02F 1/006; C02F 1/004; C02F 2209/001; C02F 2209/02; C02F 2209/22; C02F 2209/05; C02F 2209/06; C02F 2209/10; C02F 2209/11; C02F 2209/40; C02F 2209/04

(57) ABSTRACT

An automatic sewage regulation system and a regulating method are provided. The automatic sewage regulation system includes buffer tanks, an equalization tank, a sewage treatment apparatus and an automatic sewage regulating device. The automatic sewage regulating device includes sensing modules for sensing and transmitting water quality sensing values of sewage in the buffer tanks to a control module which outputs regulating signals to water flow regulators, so that the water flow regulators can regulate flowing volumes of the sewage of the buffer tanks according to the regulating signal, to keep a water quality sensing value of the sewage in the equalization tank within a preset range, thereby preventing the equalization tank from converging sewage having excessively-high or excessively-low water quality sensing value. As a result, burden of the sewage treatment apparatus can be reduced, and the lifetime of the sewage treatment apparatus can be extended.

### BACKGROUND OF THE INVENTION

### 1. Field of the Invention

The present invention provides an automatic sewage regulation system and a regulating method thereof, more particularly to an automatic sewage regulation system which uses an automatic sewage regulating device to regulate sewage outflow volumes of a plurality of buffer tanks, to keep a water quality sensing value of sewage in an equalization tank within a preset range, so as to reduce a burden of sewage treatment apparatus for sequential treatment, thereby extending lifetime of the sewage treatment apparatus.

### 2. Description of the Related Art

With the rapid development of science technology and industry, environmental pollution is becoming more and more serious. Among the environmental problems, the problem of water pollution is the most serious, so plating industry, food processing industry, dyeing industry, traditional industry, semiconductor industry or high-tech industry need sewage treatment plants to treat the discharged sewage. During sewage treatment process, the sewage treatment plant first separates inflow pipelines according to the industry, measures the inflow water quality status and water volumes of the inflow pipelines, and then converges the multiple sewage sources. Next, a purification process, such as sedimentation, mixing, aeration or filtration, is performed on the converged sewage. The water quality of the purified sewage must be detected, and when the water quality of the purified sewage can meet a sewage discharge standard, the purified sewage can be discharged to an external water area.

However, it is hard to predict the volumes and pollution degrees of sewage discharged by various industries, so when a highly-polluting factory suddenly discharges a large volume of highly-polluted sewage to the sewage treatment plant, the sudden inflow of high-polluting sewage possibly damages the purification apparatus in the sewage treatment plant. Furthermore, in order to cope with the sudden highly-polluted sewage, more manpower is required to add extra dosages in the purification apparatus, and it increases extra manpower and dosage cost. Furthermore, most highly-polluting factories discharge sewage during the daytime and not evening period, so these purification apparatuses can only purify and treat low-polluting sewage during the evening period, and it results in a low facility utilization rate of the purification apparatus. When the purification apparatus cannot be effectively utilized, many resources of the sewage treatment plant are wasted.

Therefore, what is needed is to develop an automatic sewage regulation system to solve above-mentioned problems.

### SUMMARY OF THE INVENTION

In order to solve above-mentioned problems, inventors develop an automatic sewage regulation system and a regulating method thereof according to collected data, multiple tests and modification, and years of research experience.

An objective of the present invention is that an automatic sewage regulating device can use a plurality of sensing modules to sense water quality sensing values of sewage in plurality of buffer tanks, and transmit the sensed water quality sensing values to a control module of the automatic sewage regulating device, and the control module can output regulating signals to a plurality of water flow regulators of the automatic sewage regulating device according to the water quality sensing values, so that the water flow regulators can regulate volumes of sewage flowing from the buffer tanks to the equalization tank according to the received regulating signals, so as to keep a water quality sensing value of sewage converging into the equalization tank from the buffer tanks within a preset range. The sewage treatment apparatus can purify the sewage in the equalization tank to meet a sewage discharge standard. As a result, since the automatic sewage regulating devices are used to stably keep the water quality sensing value of the sewage in the equalization tank within the preset range, it prevents the equalization tank from converging sewage having excessively-high or excessively-low water quality sensing value, so as to reduce the burden of the sewage treatment apparatus for sewage treatment and extend the lifetime of the sewage treatment apparatus. Furthermore, the water quality sensing value of the sewage in the equalization tank can be kept within the preset range stably, so that the dosage for the purification process of the sewage treatment apparatus can be kept in a stable amount, thereby achieving the purpose of reducing sewage treatment cost.

Another objective of the present invention is that each of the buffer tanks can use the automatic sewage regulating device to automatically regulate the water outflow volume thereof, to extend a time period in which the sewage having the high water quality sensing value flows into the equalization tank, so as to extend a facility utilization time of the sewage treatment apparatus and increase a facility utilization rate of the sewage treatment apparatus, thereby achieving the purpose of efficient operation and reduced cost.

Another objective of the present invention is that each of the buffer tanks can use the automatic sewage regulating device to automatically regulate the outflow volume thereof, to keep the water quality sensing value of the sewage in the equalization tank within the preset range stably, so that the dosage for the purification process of the sewage treatment apparatus can be kept in a stable amount to save manpower for treatment, thereby achieving purpose of improving purification effect, reducing operational cost and improving operational convenience.

### BRIEF DESCRIPTION OF THE DRAWINGS

The structure, operating principle and effects of the present invention will be described in detail by way of various embodiments which are illustrated in the accompanying drawings.

FIG. 1 is a block diagram of an automatic sewage regulation system of the present invention.

FIG. 2 is a block diagram of a sewage treatment apparatus of the present invention.

FIG. 3 is a flowchart of a regulating method of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be acknowledged that although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the word “comprise” and variations such as “comprises” or “comprising”, will be acknowledged to imply the inclusion of stated elements but not the exclusion of any other elements.

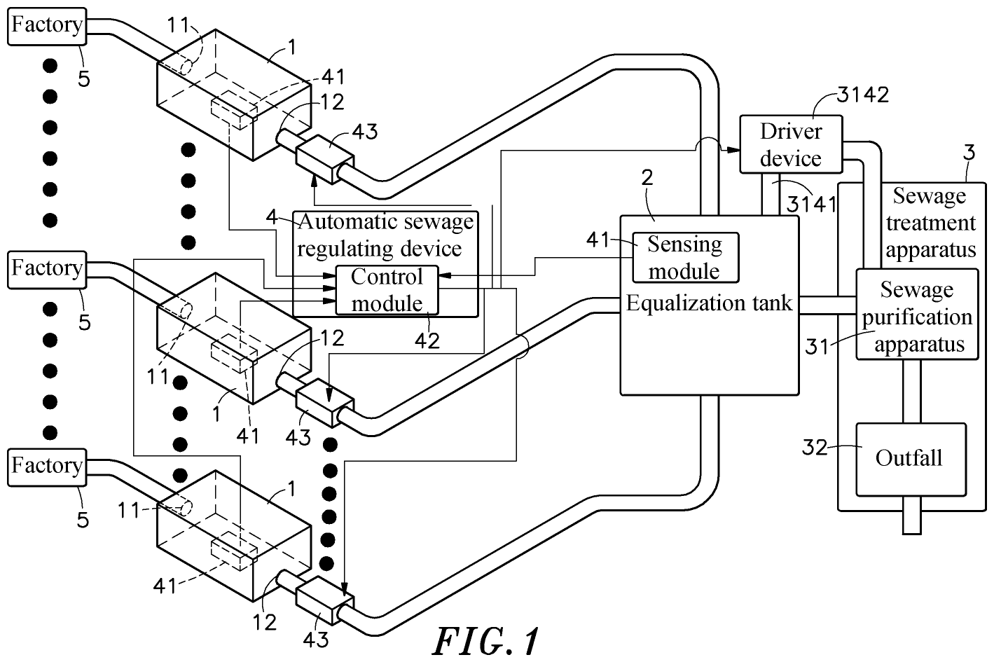

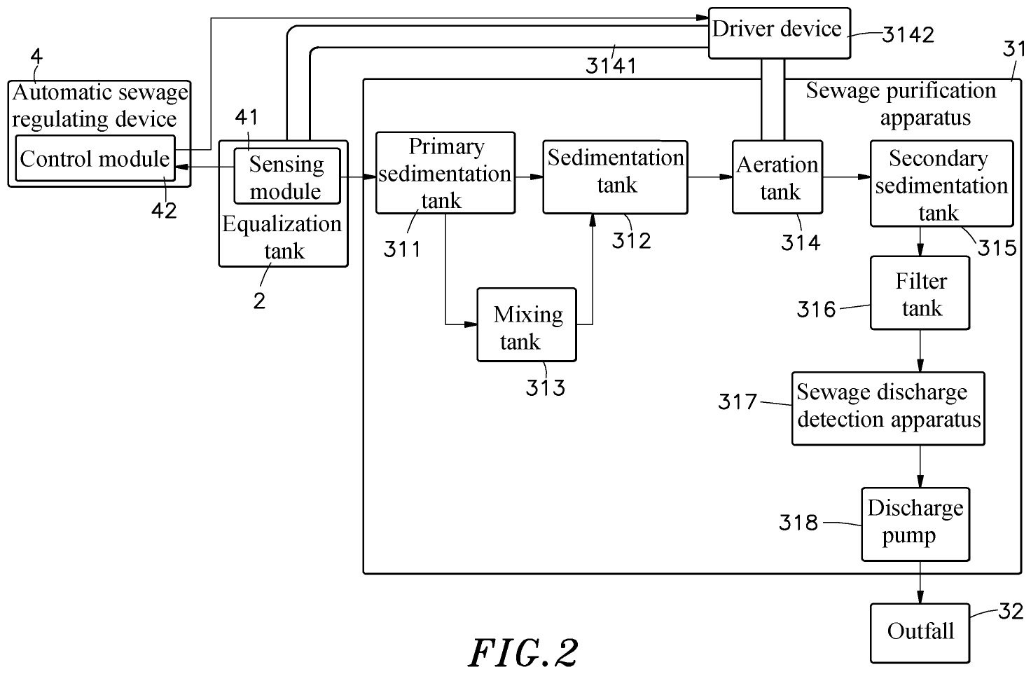

Please refer to FIGS. 1 and 2, which show a block diagram of an automatic sewage regulation system of the present invention and a block diagram of a sewage treatment apparatus of the present invention. As shown in FIG. 1, the automatic sewage regulation system can comprise a plurality of buffer tanks 1, an equalization tank 2, a sewage treatment apparatus 3 and an automatic sewage regulating device 4.

Each of the plurality of buffer tanks 1 comprises a water inlet 11 configured for sewage inflow and a water outlet 12 configured for sewage outflow.

The equalization tank 2 is connected to the water outlets 12 of the plurality of buffer tanks 1.

The sewage treatment apparatus 3 is connected to the equalization tank 2, and can include a sewage purification apparatus 31 for purifying the sewage discharged from the equalization tank 2 to meet a sewage discharge standard, and an outfall 32 formed on a side of the sewage purification apparatus 31 and configured to discharge the purified sewage to a preset water area, such as reservoir, river, lake, water bath, ditch or sea. The sewage purification apparatus 31 can include a primary sedimentation tank 311, a sedimentation tank 312 in communication with a side of the primary sedimentation tank 311, a mixing tank 313 in communication with the sedimentation tank 312 and the other side of the primary sedimentation tank 311, an aeration tank 314 in communication with other side of the sedimentation tank 312, a secondary sedimentation tank 315 in communication with other side of the aeration tank 314, a filter tank 316 in communication with other side of the secondary sedimentation tank 315, and a sewage discharge detection apparatus 317 disposed on a side of the filter tank 316 and configured to detect whether the water quality of the sewage in the filter tank 316 meets the sewage discharge standard, and a discharge pump 318 disposed on a side of the sewage discharge detection apparatus 317 and configured to draw the purified sewage to the outfall 32.

The automatic sewage regulating device 4 includes a plurality of sensing modules 41 disposed in the plurality of buffer tanks 1 and the equalization tank 2, respectively, and configured to sense water quality sensing values including turbidity values, suspended-solid values, dissolved oxygen values, temperatures, conductivity values, pH values, oxidation reduction potential values, total dissolved-solid values, biochemical oxygen demand (BOD) values, chemical oxygen demand (COD) values, ammonia nitrogen values, heavy metal values or flow rates. The sensing modules 41 are electrically connected to a control module 42 which can receive the water quality sensing values and generate water flow regulation signals according to the water quality sensing values. A plurality of water flow regulators 43 are electrically connected to the control module 42 and disposed in the water outlets 12 of the buffer tanks 1, respectively, and configured to regulate flow volumes of the sewage flowing from the buffer tanks 1 into the equalization tank 2 according to the regulating signals transmitted by the control module 42.

In an embodiment, each of the sensing modules 41 of the automatic sewage regulating device 4 can be a water quality sensor for sensing a water quality sensing value indicating a state of the water, for example, the water quality sensor can be a temperature sensor, a conductivity sensor, a pH value sensor, a dissolved oxygen sensor, a total dissolved-solid sensor, an oxidation reduction potential sensor, a turbidity sensor, a suspended-solid sensor, a biochemical oxygen demand sensor, a chemical oxygen demand sensor, an ammonia nitrogen sensor, a heavy metal sensor or a flow meter.

Furthermore, the water flow regulator 43 of the automatic sewage regulating device 4 can be a device for controlling a volume of the water flow. For example, the water flow regulator 43 can be a pump, an electric flow regulating valve, or a frequency converter.

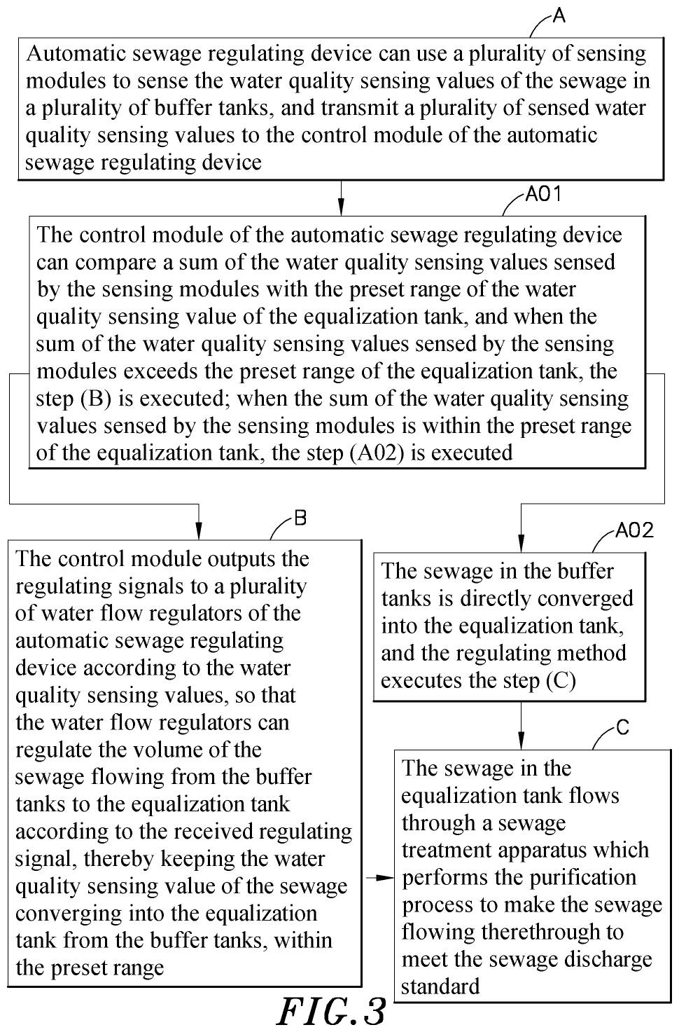

Please refer to FIG. 3, which is a flowchart of a regulating method of the present invention. As shown in FIG. 1, the regulating method can be executed by the automatic sewage regulation system of the present invention, and include steps (A) to (C), (A01), and (A02).

In a step (A), the automatic sewage regulating device 4 can use the sensing modules 41 to sense the water quality sensing values of the sewage in the buffer tanks 1, and transmit the sensed water quality sensing values to the control module 42 of the automatic sewage regulating device 4.

In a step (B), the control module 42 outputs the regulating signals to the water flow regulators 43 of the automatic sewage regulating device 4 according to the water quality sensing values, so that the water flow regulators 43 can regulate the volume of the sewage flowing from the buffer tanks 1 to the equalization tank 2 according to the received regulating signal, thereby keeping the water quality sensing value of the sewage converging into the equalization tank 2 from the buffer tanks 1, within the preset range.

In a step (C), the sewage in the equalization tank 2 flows through the sewage treatment apparatus which performs the purification process to make the sewage flowing therethrough to meet the sewage discharge standard. As a result, the operation of the automatic sewage regulation system of the present invention is completed.

Each of the buffer tanks 1 can have the water inlet 11 disposed on a side thereof, and the water outlet 12 disposed on the other side thereof, and the water outlets 12 of the buffer tanks 1 are in communication with the equalization tank 2 together. The sewage discharged from factories 5, such as factories in traditional industry, semiconductor industry, high technology industry or other industry, can flow into the water inlets 11 of the buffer tanks 1, and the sewage can flow into the equalization tank 2 via the water outlets 12 of the buffer tanks 1.

Furthermore, before the step (B), the regulating method of the present invention can execute steps (A01) and (A02).

In a step (A01), the control module 42 of the automatic sewage regulating device 4 can compare a sum of the water quality sensing values sensed by the sensing modules 41 with the preset range of the water quality sensing value of the equalization tank 2, and when the sum of the water quality sensing values sensed by the sensing modules 41 exceeds the preset range of the equalization tank 2, the regulating method executes the step (B); and, when the sum of the water quality sensing values sensed by the sensing modules 41 is within the preset range of the equalization tank 2, the regulating method executes a step (A02).

In a step (A02), the sewage in the buffer tanks 1 is directly converged into the equalization tank 2, and the regulating method executes the step (C).

In the step (A01), when the control module 42 of the automatic sewage regulating device 4 determines that the sum of the water quality sensing values is higher than the preset range of the water quality sensing value of the equalization tank 2, the buffer tank 1 receiving the more-concentrated sewage having a high water quality sensing value can reduce the outflow volume thereof by the water flow regulators 43 thereof, and the buffer tank 1 having the less-concentrated sewage having a low water quality sensing value can increase or keep the outflow volume thereof by using the water flow regulator 43 thereof, so as to keep the water quality sensing value of the sewage in the equalization tank 2 within the preset range. When the control module 42 of the automatic sewage regulating device 4 determines that the sum of the water quality sensing values is lower than the preset range of the water quality sensing value of the equalization tank 2, the buffer tank 1 having the more-concentrated sewage with a high water quality sensing value can increase the outflow volume thereof by using the water flow regulator 43 thereof, and the buffer tank 1 having the less-concentrated sewage with a low water quality sensing value can decrease or keep the outflow volume thereof by using the water flow regulator 43 thereof, so as to keep the water quality sensing value of the sewage in the equalization tank 2 within the preset range.

In an embodiment, the automatic sewage regulating device 4 can include a sensing module 41 disposed in the equalization tank 2. In the step (A), the sensing module 41 disposed in the equalization tank 2 can transmit the water quality sensing value of the sewage in the equalization tank 2 to the control module 42 of the automatic sewage regulating device 4; as a result, the sensing module 41 in the equalization tank 2 can be used to sense the water quality sensing value of the sewage in the equalization tank 2 in real time, to indeed keep the water quality sensing value of the sewage in the equalization tank 2 converging from the buffer tanks 1, within the preset range, thereby improving operational accuracy of regulating sewage volumes of the plurality of buffer tanks 1.

In the step (C), the sewage treatment apparatus 3 can use the primary sedimentation tank 311, the sedimentation tank 312, the mixing tank 313, the aeration tank 314, the secondary sedimentation tank 315 and the filter tank 316 of the sewage purification apparatus 31 to purify the sewage, and use the sewage discharge detection apparatus 317 to monitor whether the water quality of the sewage in the filter tank 316 meets the sewage discharge standard. When the water quality of the sewage in the filter tank 316 meets the sewage discharge standard, the discharge pump 318 can draw the purified sewage to the outfall 32 for discharging.

Furthermore, the aeration tank 314 of the sewage purification apparatus 31 can comprise an aeration reflow pipeline 3141 disposed on a side thereof and in communication with the equalization tank 2, and a driver device 3142 disposed on the aeration reflow pipeline 3141 and electrically connected to the control module 42. In an embodiment, the driver device 3142 can be a pump. When the sensing modules 41 of the automatic sewage regulating device 4 sense that a sum of concentration of the water quality sensing values is higher than a preset tolerable concentration of the sewage treatment apparatus, the control module 42 enables the driver device 3142 to make aerated water of the aeration tank 314 reflow to the equalization tank 2 via the aeration reflow pipeline 3141, so as to keep the water quality sensing value of the equalization tank 2 within the preset tolerable concentration of the sewage treatment apparatus 3, and stably keep the water quality sensing value of the sewage the equalization tank 2 converging from the plurality of buffer tanks 1 within the preset range, thereby facilitating the sewage treatment apparatus 3 to effectively perform purification operation and preventing the sewage treatment apparatus 3 from being damaged by impact of more-concentrated sewage.

In an embodiment, the automatic sewage regulating device 4 can include a sensing module 41 disposed in the equalization tank 2, and when the sensing module 41 senses that the water quality sensing value of the sewage in the equalization tank 2 is higher than the preset tolerable concentration of the sewage treatment apparatus 3, the aeration tank 314 of the sewage treatment apparatus 3 can reflow internal aerated water into the equalization tank 2, so as to reduce the water quality sensing value of the sewage in the equalization tank 2 below the value of the preset tolerable concentration of the sewage treatment apparatus 3.

In practical usage of the automatic sewage regulation system of the present invention, the sensing modules 41 of the automatic sewage regulating device 4 can be used to sense the water quality sensing values of the sewage in the plurality of buffer tanks 1, and the sensing modules 41 can transmit the sensed water quality sensing values to the control module 42 to perform analysis and calculation for regulation operation, and then the control module 42 can output the regulating signals to the water flow regulators 43, the water flow regulators 43 can regulate the flow volumes of the sewage flowing from the buffer tanks 1 upon receipt of the received regulating signals, so as to keep the water quality sensing values of the sewage converging to the equalization tank 2 from the plurality of buffer tanks 1 within the preset range, and before the sewage in the equalization tank 2 is discharged outwardly, the sewage treatment apparatus 3 can purify and filter the sewage in the equalization tank 2 to meet the sewage discharge standard. Since the buffer tanks 1 can regulate the outflow volumes thereof by the automatic sewage regulating device 4, the water quality sensing value of the sewage in the equalization tank 2 can be kept within the preset range, to prevent the sewage having excessive-high or excessive-low water quality sensing value from converging into the equalization tank 2. As a result, the burden of the sewage treatment apparatus 3 for treating sewage can be reduced, and the lifetime of the sewage treatment apparatus 3 can be extended.

According to above-mentioned content, the automatic sewage regulation system and the regulating method of the present invention have advantages below.

First, the automatic sewage regulating device 4 can automatically regulate the outflow volumes of the buffer tanks 1, to keep the water quality sensing value of the sewage in the equalization tank 2 within the preset range stably, so as to prevent the sewage having excessive-high or excessive-low water quality sensing value from converging into the equalization tank 2, thereby reducing the burden of the sewage treatment apparatus 3 for treating sewage and extending the lifetime of the sewage treatment apparatus 3. Since the water quality sensing value of the sewage in the equalization tank 2 is kept within the preset range stably, so that the dosage for the purification process of the sewage treatment apparatus 3 can be kept in a stable amount, and the sewage treatment cost can be reduced.

Secondly, the buffer tanks 1 can automatically regulate the outflow volumes by the automatic sewage regulating device 4, so that the time period in which the sewage having high water quality sensing value flows into the equalization tank 2 can be extended, and the facility utilization time of the sewage treatment apparatus 3 can be extended, thereby increasing the facility utilization rate of the sewage treatment apparatus 3, and achieving the effect of improving operational efficiency and reducing operational cost.

Thirdly, the buffer tanks 1 can automatically regulate the outflow volumes by the automatic sewage regulating device 4, to stably keep the water quality sensing value of the sewage in the equalization tank 2 within the preset range, so that the sewage treatment apparatus 3 can use the dosage in a stable amount for purification process, thereby saving manpower for treatment and achieving effect of improving purification, reducing operational cost, and improving convenience in operation.

The present invention disclosed herein has been described by means of specific embodiments. However, numerous modifications, variations and enhancements can be made thereto by those skilled in the art without departing from the spirit and scope of the disclosure set forth in the claims.

1. An automatic sewage regulation system comprising:
a plurality of buffer tanks, wherein each of buffer tanks comprises a water inlet configured for sewage inflow, and a water outlet configured for sewage outflow;
an equalization tank connected to the water outlets of the buffer tanks, and configured for the sewage inflows from the buffer tanks;
a sewage treatment apparatus connected to the equalization tank for purifying the sewage discharged from the equalization tank; and
an automatic sewage regulating device comprising a plurality of sensing modules disposed in the buffer tanks, respectively, and a control module, and a plurality of water flow regulators, wherein the sensing modules are configured to sense water quality sensing values of sewage in the buffer tanks, and the control module is electrically connected to the sensing modules and configured to receive the water quality sensing values and generate water flow regulation signals, and the water flow regulators are disposed on the water outlets of the buffer tanks, respectively, and electrically connected to the control module, and configured to regulate flow volumes of the sewage in the buffer tanks flowing into the equalization tank according to the regulating signals transmitted by the control module, so as to keep a water quality sensing value of the sewage converging into the equalization tank from the buffer tanks within a preset range.

2. The automatic sewage regulation system according to claim 1, wherein the sewage treatment apparatus comprises a sewage purification apparatus configured to purify the sewage, which is discharged from the equalization tank, to meet a sewage discharge standard, and the sewage treatment apparatus comprises an outfall formed on a side thereof and configured to discharge purified sewage to a preset water area.

3. The automatic sewage regulation system according to claim 2, wherein the sewage purification apparatus comprises a primary sedimentation tank, the primary sedimentation tank in communication with a sedimentation tank and a mixing tank, and the mixing tank in communication with the sedimentation tank, an aeration tank in communication with the sedimentation tank, a secondary sedimentation tank in communication with the aeration tank, a filter tank in communication with the secondary sedimentation tank, and a sewage discharge detection apparatus disposed on a side of the filter tank and configured to detect whether water quality of the sewage in the filter tank meets the sewage discharge standard, and the sewage discharge detection apparatus comprises a discharge pump disposed on a side thereof and configured to draw the purified sewage to the outfall.

4. The automatic sewage regulation system according to claim 1, wherein the automatic sewage regulating device comprises a sensing module disposed in the equalization tank and configured to sense a water quality sensing value of the sewage in the equalization tank.

5. The automatic sewage regulation system according to claim 1, wherein the sensing module of the automatic sewage regulating device is a temperature sensor, a conductivity sensor, a pH value sensor, a dissolved oxygen sensor, a total dissolved-solid sensor, an oxidation reduction potential sensor, a turbidity sensor, a suspended-solid sensor, a biochemical oxygen demand sensor, a chemical oxygen demand sensor, an ammonia nitrogen sensor, a heavy metal sensor or a flow meter, and each of the water flow regulators of the automatic sewage regulating device is a pump, an electric flow regulating valve, or a frequency converter.

6. A regulating method applicable to an automatic sewage regulation system, comprising:
(A) using a plurality of sensing modules of an automatic sewage regulating device to sense water quality sensing values of sewage in a plurality of buffer tanks, and transmitting the sensed water quality sensing values to a control module of the automatic sewage regulating device;
(B) using the control module to output regulating signals to a plurality of water flow regulators of the automatic sewage regulating device according to the water quality sensing values, to make the water flow regulators regulate flow volumes of the sewage flowing to the equalization tank according to the received regulating signals, so as to keep a water quality sensing value of the sewage converging into the equalization tank from the buffer tanks within a preset range; and
(C) flowing the sewage discharged from the equalization tank through a sewage treatment apparatus, and performing the purification process to meet the sewage discharge standard.

7. The regulating method according to claim 6, wherein before the step (B), further comprising:
(A01) using the control module of the automatic sewage regulating device to compare a sum of the water quality sensing values sensed by the plurality of sensing modules with the preset range of the water quality sensing value of the equalization tank, and executing the step (B) when the sum of the water quality sensing values sensed by the plurality of sensing modules exceeds the preset range of the water quality sensing value of the equalization tank, and executing step (A02) when the sum of the water quality sensing values sensed by the sensing modules is within the preset range of the water quality sensing value of the equalization tank; and
(A02) directly converging the sewage of the plurality of buffer tanks into the equalization tank, and executing the step (C).

8. The regulating method according to claim 7, wherein the step (A01), when the control module of the automatic sewage regulating device determines that the sum of the water quality sensing values is higher than the preset range of the water quality sensing value of the equalization tank, the buffer tank having the more-concentrated sewage with a high water quality sensing value uses the water flow regulators to reduce an outflow volume, and the buffer tank having the less-concentrated sewage with a low water quality sensing value increases or keeps the outflow volume, so as to keep the water quality sensing value of the sewage in the equalization tank within the preset range, and when the control module of the automatic sewage regulating device determines that the sum of the water quality sensing values is lower than the preset range of the water quality sensing value of the equalization tank, the buffer tank having the more-concentrated sewage with a high water quality sensing value uses the water flow regulators to increase the outflow volume, and the buffer tank having the less-concentrated sewage with a low water quality sensing value decreases or keeps the outflow volume, so as to keep the water quality sensing value of the sewage in the equalization tank within the preset range.

9. The regulating method according to claim 6, wherein, in the step (C), the sewage treatment apparatus uses a primary sedimentation tank, a sedimentation tank, a mixing tank, an aeration tank, a secondary sedimentation tanks and a filter tank of the sewage purification apparatus to purify sewage, and use a sewage discharge detection apparatus to monitor whether the water quality of the sewage in the filter tank meets the sewage discharge standard, and when the water quality of the filter tank meets the sewage discharge standard, a discharge pump is used to draw the purified sewage to an outfall on a side of the sewage treatment apparatus for discharging.

10. The regulating method according to claim 9, wherein the sewage purification apparatus comprises an aeration reflow pipeline disposed on a side of the aeration tank and in communication with the equalization tank, and a driver device disposed on the aeration reflow pipeline and electrically connected to the control module, and when the sensing modules of the automatic sewage regulating device sense that a sum of concentration of the water quality sensing values is higher than a preset tolerable concentration of the sewage treatment apparatus, the control module enables the driver device to reflow aerated water of the aeration tank into the equalization tank via the aeration reflow pipeline, so as to keep the water quality sensing value in the equalization tank within the preset tolerable concentration of the sewage treatment apparatus, thereby keeping the water quality sensing values of the sewage converging into the equalization tank from the buffer tanks within the preset range, and the automatic sewage regulating device includes a sensing module disposed in the equalization tank, when the sensing module senses that the water quality sensing value in the equalization tank is higher than the preset tolerable concentration of the sewage treatment apparatus, the aeration tank of the sewage treatment apparatus reflows the aerated water into the equalization tank, so as to reduce the water quality sensing value of the sewage in the equalization tank below the preset tolerable concentration of the sewage treatment apparatus.
